(19) United States
(12) Patent Application Publication
(10) Pub. No.: US 2007/0147807 A1
(43) Pub. Date: Jun. 28, 2007

(54) Control unit

(76) Inventors: Kurt Schunke, Minden (DE); Bernd Buchholz, Rahden (DE); Dieter Palm, Werther (DE)

Correspondence Address: BARNES & THORNBURG LLP, 750-17TH STREET NW, SUITE 900, WASHINGTON, DC, 20006-4675, US

(21) Appl. No.: 10/565,025

(22) PCT Filed: Jul. 9, 2004
(86) PCT No.: PCT/EP04/07548

§ 371 Date: Nov. 27, 2006

(30) Foreign Application Priority Data
Jul. 22, 2003 (DE) 20311221.0

(51) Int. Cl. H02P 5/00

(52) U.S. Cl. 388/903

(57) ABSTRACT

A control unit for an electric motor of an actuator. The control unit including a controller, a capacitive energy storage device having a charge voltage, a temperature sensor to measure an ambient temperature, and a charge converter.

### BACKGROUND AND SUMMARY

The present disclosure relates to a control unit for an electric motor, particularly for an electric motor of an actuator. The control unit is equipped with a control board and a capacitive energy storage device which can be charged by the supply network in order to supply power to the electric motor in the event of a power failure.

The control unit is particularly suitable for the electric motors of actuators whose outputs are relatively low. Such actuators are used in the safety field, among other fields. The actuators are used, for example, in the event of developing smoke caused by a fire or in the case of a power failure or other emergencies, to move an actuator into a position optimal for a respective case, for example, in order to open or close a flap. Solutions are also known in which the movement into a safety position takes place by mechanical structural elements, such as springs. However, since these mechanical components remain without a function in the normal operation, they may not be operable when a safety situation occurs. Furthermore, it is disadvantageous that the structural element to be adjusted is moved by a purely mechanical drive into an end position which is not necessarily optimal. For the above-mentioned reasons, solutions such as electrical solutions are considered. However, since the possibility exists that the power supply for the electric motor has already failed when the safety function is needed, it is known to supply the electric motor by an auxiliary voltage source. Since the electric motors are d. motors, an auxiliary voltage source would offer one or more accumulators. However, these auxiliary voltage sources have the disadvantage that over time they discharge in an uncontrolled manner so that the energy still to be supplied will not be sufficient for starting the electric motor.

It has therefore been suggested to use a capacitive storage device as an energy storage device which is charged from the power supply network. It is an advantage that the full capacity or energy is always available. It is advantageous for this capacitive storage device to be fed from the circuit of the electric motor. In the case of a known control unit or in the case of a known safety circuit, the capacitive storage device is charged from the power supply network but, in the event that the electric motor has to be supplied from the storage device, a switch, preferably a relay, is switched. This also still results in an uncertainty since this switch or the relay is not operated in the normal operation, so that an operational check also would have to be carried out. In the case of capacitive energy storage devices, the intensity of the supplied current and thus also of the torque applied by the electric motor depends on the ambient temperature. When the electric motor is used for an actuator, depending on the usage case or site, the ambient temperatures fluctuate in a wide range, for example, between −25° C. and +25° C. At these indicated values, the torque to be applied at a temperature of −25° C. amounts to only half the torque which would be applied at a temperature of +25° C. However, since a certain torque is required, the capacitive energy storage device has to be designed for the lowest temperature, so that an overdimensioning takes place in many usage cases. In addition, the capacitive energy storage devices are subjected to an aging process. However, this aging process is accelerated, the higher the ambient temperature and the operational voltage. A service life is defined for the considered usages. So that this service life is achieved, care has to be taken that the operational voltage of the capacitive energy storage device will remain under its nominal voltage at temperatures in the upper range, so that the planned service life will be reached.

The present disclosure is related to a control unit such that a temperature-dependent acceleration of the aging process or the reduction of the storage capacity of the capacitive energy storage device is effectively avoided. Furthermore, a length of operation is not decreased by an excess voltage.

An illustrative embodiment of the control unit of the present disclosure includes a sensor, or a sensor is assigned to the control unit, for determining the ambient temperature such that a measured temperature can be converted to control signals by a converter. Moreover, a charge voltage of a capacitive energy storage device can be controlled as a function of the temperature by a voltage converter.

The ambient temperature for an included electric motor is measured continuously. As a result, it is ensured that, at extremely low and also at extremely high temperatures, a continuously constant or approximately constant torque can be applied by the electric motor. That is because the operational voltage for the capacitive energy storage device, apart from slight fluctuations, is always constant. As a result, neither a temperature-dependent nor a voltage-dependent aging process is promoted. Therefore, the above-noted overdimensioning is eliminated since it can be assumed that the control unit is used in many different temperature ranges with extremely different temperatures. In addition, not only the defined service life of the capacity energy storage device is reached but the stored energy is also sufficient so that the electric motor will deliver a sufficient driving torque.

An implementation of voltage control can take place in multiple ways. Thus, the present disclosure provides that the operational voltage for the capacitive energy storage device can be controlled by a charge converter as a function of the temperature to a constant or approximately constant value. Constructively, the control unit is particularly simple but is also offers a high operational reliability if the capacitive energy storage device is constantly acted upon by its respective operational voltage. As a result, the charge condition becomes constant so that the electric motor can be supplied with current from the capacitive energy storage device at any time. The temperature sensor or temperature probe may be arranged outside the control unit. However, in an illustrative embodiment, it is provided that the temperature sensor is integrated in the control board. As a result, lines to the control unit are avoided. Furthermore, the temperature sensor or temperature probe would be protected.

The capacitive energy converter should be arranged within the electrical circuit of the motor, because the lower motor voltage then has to be controlled. Normally, the electric motor is also acted upon by a direct safety current. The electric motor could then directly, if required, be acted upon by the voltage from the capacitive energy storage device. If the capacitive energy storage device is not acted upon by voltage from the motor circuit, it is provided that, if the electric motor is acted upon by voltage from the energy storage device, the voltage can be converted by a discharge converter.

Other aspects of the present disclosure will become apparent from the following descriptions when considered in conjunction with the accompanying drawings.

### BRIEF DESCRIPTION OF THE DRAWINGS

FIG. 1 is a block diagram showing an embodiment of a control unit according to the present disclosure.

FIG. 2 is a block diagram showing another embodiment of a control unit according to the present disclosure.

### DETAILED DESCRIPTION

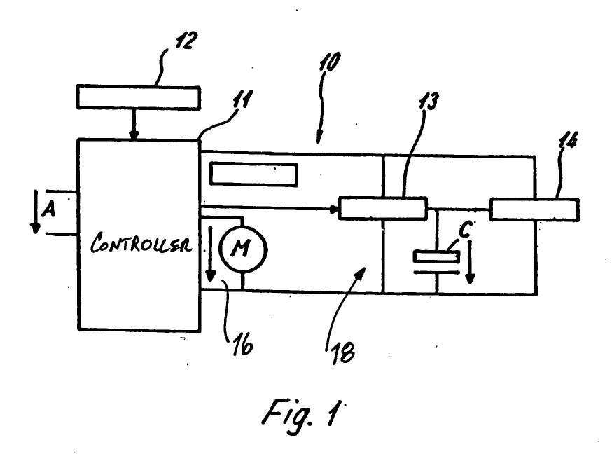

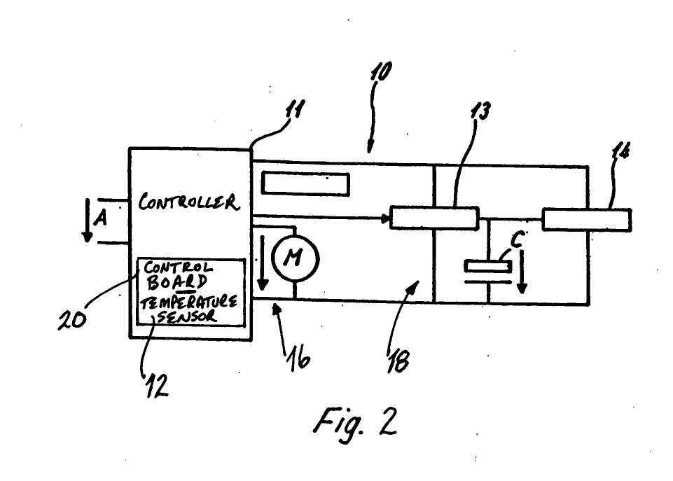

For reasons of a simple representation, FIG. 1 shows a block diagram of a control unit 10. The control unit 10 includes a controller 11 into which values are fed which are measured by a temperature sensor 12 or a temperature probe. Temperature sensor 12 may be assigned to controller 11, as shown in FIG. 1, or may be integrated in controller 11, as shown in FIG. 2. As illustrated by the arrow A, the controller 11 is acted upon by a voltage. The intensity of the voltage may be a normal line voltage. A transformer and a rectifier may be installed in the controller 11 in order to convert a normal alternating (AC) voltage to a direct (DC) safety voltage. However, it is also conceivable that the transformer is mounted outside the controller 11, so that the direct safety voltage is fed into the controller 11. FIG. 1 shows two electric circuits leading from the controller 11, including a first electric circuit 16 acting upon an electric motor M and a second electric circuit or supply network 18 acting upon a capacitive energy storage device C. A charge converter 13 is also installed in the second electric circuit 18, which charge converter 13 controls or provides an outgoing current as a function of the temperature to either a constant or approximately constant value. As a result, the capacitive energy storage device C is always acted upon by the same or approximately the same charge voltage or operational voltage. The charge or operational voltage is therefore present at the energy storage device C. In the event of a power failure, the motor M is either directly acted upon from the capacitive energy storage device C, or the charge or operational voltage is, in addition, converted by a discharge converter or switch 14.

The controller 11 includes a control board 20 which may contain the temperature sensor 12 or the temperature probe.

The present disclosure is not limited to the illustrated embodiment. It is important that the ambient temperature of the electric motor M is determined and that the charge voltage of the capacitor C is always constant or approximately constant, even if the ambient temperatures fluctuate to an extreme degree or are different. For this purpose, the control unit 10 is equipped with charge converter 13.

Although the present disclosure has been described and illustrated in detail, it is to be clearly understood that this is done by way of illustration and example only and is not to be taken by way of limitation. The scope of the present disclosure is to be limited only by the terms of the appended claims.

What is claimed is:

1. A control unit for an electric motor of an actuator, the control unit comprising:
a controller;
a capacitive energy storage device chargeable by a supply network to supply power to the electric motor in the event of a power failure, the capacitive energy storage device having a charge voltage;
a temperature sensor assigned to the control unit to measure an ambient temperature; and
a charge converter configured to convert the measured ambient temperature into a control signal to control the charge voltage of the capacitive energy storage device as a function of the measured ambient temperature.

2. The control unit according to claim 1, wherein an operational voltage for the capacitive energy storage device is controlled by the charge converter as a function of the measured ambient temperature to an approximately constant value.

3. The control unit according to claim 1 or 2, wherein the capacitive energy storage device is continuously acted upon by the operational voltage.

4. The control unit according to claim 1, wherein the temperature sensor is integrated in the controller of the control unit.

5. The control unit according to claim 1, wherein the capacitive energy storage device is acted upon by electric energy from an electric motor circuit.
